(19) United States
(12) Patent Application Publication
(10) Pub. No.: US 2003/0101166 A1
(43) Pub. Date: May 29, 2003

(54) Information analyzing method and system

(75) Inventors: Kanji Uchino, Kawasaki (JP); Yuki Kume, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/101,282

(22) Filed: Mar. 20, 2002

(30) Foreign Application Priority Data
Nov. 26, 2001 (JP) 2001-359484

(51) Int. Cl. G06F 7/00

(52) U.S. Cl. 707/2

(57) ABSTRACT

This invention is to automatically extract noteworthy information from a large amount of information. First, a disclosure unit of an individual opinion such as a statement in a personal Web page or a bulletin board is extracted from collected content information, and information such as URL or statement number for specifying the disclosure unit of the individual opinion is registered. Next, an object such as company name or industry type of the individual opinion is specified. Then, the disclosed contents of the individual opinion are analyzed, so that an evaluation as to the object such as good evaluation or bad evaluation is specified. Besides, the reliability is determined based on referenced degree ranking and based on whether information to indicate the basis of the opinion or the identity of the speaker is included. Thus, the evaluation as to the object as characteristics of the individual opinion can be presented to requesters. Besides, for example, only a bad evaluation can be extracted from evaluations as to the object of the individual opinion. Furthermore, the opinion, which has a high influence degree and is noteworthy, can also be found based on the referenced degree ranking or the reliability.

### TECHNICAL FIELD OF THE INVENTION

This invention is related to the subject matter disclosed in the following patent and patent application of the same assignee as the present invention, the contents of which are incorporated herein by reference:

U.S. application Ser. No. 09/776635, filed on Feb. 6, 2001

U.S. application Ser. No. 048026, filed on Mar. 26, 1998

U.S. application Ser. No. 09/768062, filed on Jan. 24, 2001

U.S. application Ser. No. 266863, filed on Mar. 12, 1999

### BACKGROUND OF THE INVENTION

The present invention relates to a technique for automatically extracting specified information from a large amount of information, and more particularly to a technique for automatically extracting specified information from a large amount of information and extracting information of its characteristics or the like.

To automatically extract libels and slanders against a company from information disclosed in the Internet has been conducted by using some document searching tools hitherto. However, a method is adopted in which keywords are specified and a patrol of Web sites is made to extract them by using the specified keywords, or URLs (Uniform Resource Locator) of search objects are specified in advance to extract them. That is, such a judgment that the collected information is information of a good evaluation or information of a bad evaluation is not made. Further, information as to the influence of the collected information cannot also be obtained. Thus, it is not suitable for finding “circulation of rumor” for stock price manipulation.

Japanese Patent No. 2951307 discloses an electronic bulletin board system having a function of automatically checking the contents of a message transmitted from a user computer and desired to be presented on the electronic bulletin board. That is, with respect to the message transmitted from the user computer and desired to be presented on the electronic bulletin board, a check is made according to a glossary of presentation-inhibited words, which includes words previously selected as being unsuitable for presentation on the electronic bulletin board. In the case where any word in the glossary of presentation-inhibited words is not included in the message desired to be presented, the message is presented on the electronic bulletin board. On the other hand, in the case where any word in the glossary of presentation-inhibited words is included, a notice that the message cannot be presented is given to the user computer. Besides, at this time, the event of rejecting the presentation of the message is notified to an operation administrator computer. In such a technique, although it is possible to judge the permission or inhibition of the presentation on the bulletin board, the contents of a message judged to be capable of being presented cannot be automatically analyzed.

As stated above, according to the conventional technique, although definitely specified information can be extracted from an enormous amount of information, noticeable information cannot be automatically extracted, and the interpretation and analysis of the extracted information must be manually made. Thus, the user can not obtain the characteristics of the extracted information, the source of the information, and the like without a further operation.

### SUMMARY OF THE INVENTION

An object of the present invention is therefore to provide a novel technique for automatically extracting noticeable information from a large amount of information.

Another object of the present invention is to provide a technique for extracting specified information from a large amount of information and for enabling the characteristics of the extracted information to be presented.

Still another object of the present invention is to provide a technique for extracting specified information from a large amount of information and for enabling the reliability and/or influence of the extracted information to be presented.

Sill another object of the present invention is to provide a technique for extracting specified information from a large amount of information and for searching the source of the extracted information.

A content information analyzing method according to the present invention comprises the steps of: extracting a disclosure unit (for example, a personal Web page, a statement on a bulletin board, etc.) of an opinion of an individual from collected content information and storing information (for example, a URL, a statement number, etc.) for specifying the disclosure unit of the opinion of the individual into a storage device; specifying an object (for example, a company name, an industry type, a trade name, etc.) of the opinion of the individual and storing it into the storage device; and specifying an evaluation (for example, a good evaluation or a bad evaluation) of the object by the individual by analyzing disclosed contents of the opinion of the individual and storing it into the storage device. By this, the evaluation for the object, as the characteristics of the extracted opinion of the individual, can be presented. For example, only a bad evaluation can be extracted from evaluations for the object of the opinions of the individuals.

Besides, the aforementioned extracting step may comprise the steps of: specifying a unit (for example, one Web page) of the content information including the opinion of the individual; and extracting the disclosure unit of the opinion of the individual from the specified unit of the content information. For example, after a Web site of a bulletin board or a personal homepage is extracted, a statement or the like as the disclosure unit of the opinion of the individual is separated.

Further, the foregoing step of specifying a unit maybe carried out in descending order of a referenced degree for each unit of the content information. That the referenced degree is high indicates that the content information has a high possibility that many people see it and has a high influence, and accordingly, the content information having the high influence is processed with high priority. Besides, there is also a case where the influence itself is treated as an index to indicate whether the information is noteworthy.

Besides, the aforementioned extracting step may comprise a step of detecting a group (for example, a thread in a preferred embodiment) of the disclosure units of the opinions of the individuals by tracing a reference source of the opinion of the individual, and storing information for specifying the group into the storage device. This is because what is to be noticed exists not only as a personal statement but also as the unity of statements.

Further, the aforementioned extracting step may comprise a step of specifying a category (for example, an industry type) as to the object of the opinion of the individual and storing it into the storage device. By this, the category as the characteristics of the extracted opinion of the individual can be presented. For example, there is also a case where noticeable information, an expression of evaluation and a nuance are different between respective industry types, and the classification by respective industry types, or the like is also effective.

Besides, the present invention may further comprise a step of judging whether information which can be a basis of the opinion of the individual (for example, a referencing statement, Web site, or contents of a newspaper and/or magazine, etc.) is included in the disclosure unit of the opinion of the individual, and storing the information, which can be the basis, into the storage device in a case where it is included. By this, the source of the information as the characteristics of the extracted opinion of the individual can be presented. This is very useful when it is necessary to investigate the source of the information.

Further, the present invention may further comprise a step of determining reliability of the disclosure unit of the opinion of the individual and storing it into the storage device. By this, the reliability as the characteristics of the extracted opinion of the individual can be presented. It becomes possible to obtain a standard as to whether the information is reliable or not reliable. There is also a case where what has high reliability is extracted as noticeable information.

Incidentally, the foregoing reliability determining step may comprise a step of judging whether information indicating an identity of the individual (for example, a mail address, a handle name, etc.) is included in the disclosure unit of the opinion of the individual. This is because information, which can be opened to the public in spite of disclosure of the identity, can be judged to be reliable.

Further, the foregoing reliability determining step may comprise a step of judging whether information, which can be a basis of the opinion of the individual, is included in the disclosure unit of the opinion of the individual. This is because if the basis is clear, the information can be judged to be reliable.

A content information analyzing method according to a second aspect of the present invention comprises the steps of: extracting a disclosure unit of an opinion of an individual from collected content information and storing information for specifying the disclosure unit of the opinion of the individual into a storage device; specifying an object of the opinion of the individual and storing it into the storage device; and determining reliability of the disclosure unit of the opinion of the individual and storing it into the storage device. By this, it becomes possible to extract, for example, the opinion of the individual having high reliability. Incidentally, it is also possible to adopt such a configuration that a referenced degree of the opinion of the individual or the content information including the opinion of the individual is made an influence degree and this is treated as a parameter of automatic extraction.

Besides, there is a case where an object (for example, a company) of the opinion of the individual or a category (for example, an industry type, a trade name, etc.) of the object are determined by using a dictionary on a URL, a company name, an abbreviation, and an industry type, and/or a dictionary including feature words on respective industry types. These dictionaries can be automatically constructed by analyzing the collected content information and the like.

Incidentally, the foregoing methods can be executed by a computer, and a program executed by the computer for performing the foregoing methods is stored in a storage medium or a storage device such as, for example, a flexible disk, a CD-ROM, a magneto-optical disk, a semiconductor memory, or a hard disk. Besides, there is also a case where the program is distributed through a network or the like. Incidentally, intermediate processing results are temporarily stored in a storage device such as a memory.

### BRIEF DESCRIPTION OF THE DRAWINGS

FIG. 1 is a diagram for explaining a system outline according to an embodiment of the present invention;

FIG. 2 is a flowchart showing an example of a processing flow by an information collection and analysis system;

FIGS. 3A and 3B are tables showing an example of data stored in a bulletin board element storage;

FIGS. 4A, 4B and 4C are tables showing an example of data stored in an analyzed data storage;

FIG. 5 is a table showing an example of data stored in an industry type glossary storage;

FIG. 6 is a flowchart showing an example of a processing flow as to a statement extraction processing;

FIG. 7 is a flowchart showing an example of a processing flow as to a thread extraction processing;

FIGS. 8A and 8B are tables showing an example of data stored in a company name dictionary storage;

FIG. 9 is a flowchart showing an example of a processing flow as to a source search processing;

FIG. 10 is a flowchart showing an example of a processing flow as to an analysis processing of a statement and a thread;

FIG. 11 is a flowchart showing an example of a generation processing flow of a rule set;

FIG. 12 is a diagram showing an example of processing results of a statistical processor;

FIG. 13 is a diagram showing an example of processing results of the statistical processor;

FIG. 14 is a functional block diagram of a glossary generator;

FIG. 15 is a flowchart showing an example of a processing flow of the glossary generator;

FIG. 16 is a flowchart showing an example of a processing flow of the glossary generator; and

FIG. 17 is a diagram showing an example of processing results of the statistical processor.

### DETAIL DESCRIPTION OF THE PREFERRED EMBODIMENTS

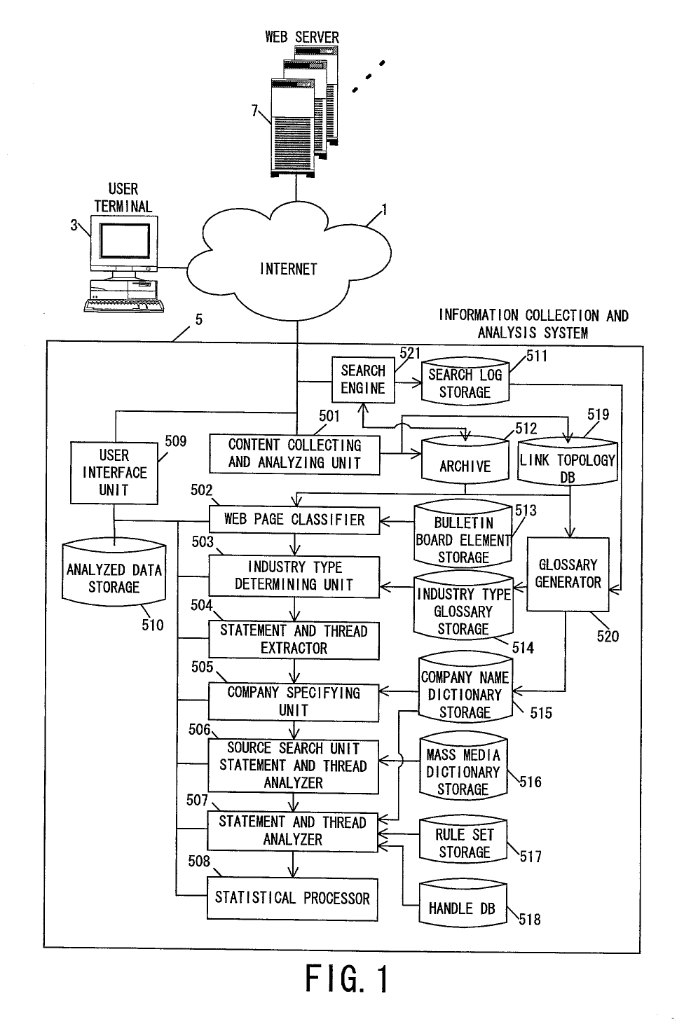

FIG. 1 shows a system outline according to an embodiment of the present invention. The Internet 1 as a computer network is connected with a large number of Web servers 7, and the Web servers 7 open an enormous amount of information to the public. Besides, the Internet 1 is connected with a large number of user terminals 3 each provided with a Web browser, and users operate the user terminals 3 to browse the Web pages opened by the Web servers 7 to the public. Further, the Internet 1 is also connected with an information collection and analysis system 5 for executing a main processing in this embodiment. This information collection and analysis system 5 provides specified users with analysis results, and further archives collected information and provides the users with a search function relating to the archived information. That is, the user terminals 3 access the information collection and analysis system 5 through the Internet 1, and can acquire analysis results explained below, and can acquire search results retrieved from the archived information.

The information collection and analysis system 5 includes a content collecting and analyzing unit 501, a Web page classifier 502, an industry type determining unit 503, a statement and thread extractor 504, a company specifying unit 505, a source search unit 506, a statement and thread analyzer 507, a statistical processor 508, a user interface unit 509, a glossary generator 520, and a search engine 521.

The content collecting and analyzing unit 501 stores collected content information, referenced degree ranking based on the analysis results of link relations concerning the content information, and the like into an archive 512, and stores link topology information as analysis results concerning reference relations between contents into a link topology DB 519. The Web page classifier 502 uses the information stored in the archive 512, and refers to bulletin board element data stored in a bulletin board element storage 513 to carry out a processing, and outputs processing results to, for example, the industry type determining unit 503, and further stores them into an analyzed data storage 510. The industry type determining unit 503 uses, for example, the output of the Web page classifier 502, and refers to an industry type glossary stored in an industry type glossary storage 514 to carry out a processing, and outputs processing results to, for example, the statement and thread extractor 504, and further stores them into the analyzed data storage 510.

The statement and thread extractor 504 uses, for example, the output of the industry type determining unit 503 to carry out a processing, and outputs processing results to, for example, the company specifying unit 505, and further stores them into the analyzed data storage 510. The company specifying unit 505 uses the output of the statement and thread extractor 504, and refers to a company name dictionary stored in a company name dictionary storage 515 to carry out a processing, and outputs processing results to, for example, the source search unit 506, and further stores them into the analyzed data storage 510. The source search unit 506 uses the output of the company specifying unit 505, and refers to a mass media dictionary stored in amass media dictionary storage 516 to carry out a processing, and outputs processing results to, for example, the statement and thread analyzer 507, and further stores them into the analyzed data storage 510.

The statement and thread analyzer 507 uses the output of the source search unit 506, and refers to the company name dictionary stored in the company name dictionary storage 515, data of rules concerning genres and evaluations of personal opinions stored in a rule set storage 517, and a handle DB 518 in the case where a handle is used on a bulletin board or the like, to carry out a processing, and outputs processing results to the statistical processor 508, and further stores them to the analyzed data storage 510. The statistical processor 508 uses the output from the statement and thread analyzer 507 or the information stored in the analyzed data storage 510 to carry out a statistical processing, and outputs processing results to, for example, the user interface unit 509 and/or the analyzed data storage 510.

The user interface unit 509 transmits data stored in the analyzed data storage 510 or the output of the statistical processor 508 to the user terminal 3 in response to an access from the user terminal 3. Besides, the search engine 521 searches data stored in the archive 512 in response to a search request from the user terminal 3, and transmits search results to the user terminal 3. The search engine 521 stores a search log into a search log storage 511. The glossary generator 520 refers to the search log storage 511, the archive 512 and the link topology DB 519 to generate the industry type glossary and the company name dictionary, and stores them into the industry type glossary storage 514 and the company name dictionary storage 515.

The content collecting and analyzing unit 501 collects data of the Web pages published by the many Web servers 7 connected to the Internet 1, and analyzes reference relations based on links, and calculates ranking values from referenced degrees of the respective Web pages. Then, the content collecting and analyzing unit 501 stores the collected data of the Web pages and the ranking values by the referenced degrees into the archive 512. Besides, it stores the reference relations based on the links as link topology data into the link topology DB 519. Since the processing of this content collecting and analyzing unit 501 uses an existing technique, and is disclosed in, for example, “http://pr.fujitsu.com/jp/news/2001/07/12.html”, a more detailed description is not given. *** This document is incorporated herein by reference. *****

The Web page classifier 502 performs a processing for automatically discriminating personal homepages and Web pages of bulletin boards from Web pages stored in the archive 512. The personal homepages and the Web pages of the bulletin boards are content information in which personal opinions are disclosed. There are not necessarily many readers, however, they can not be passed by in view of “circulation of rumor”, and the information as to the existence and the source should be recorded. In this processing, the web page classifier 502 refers to the bulletin board element storage 513 which stores bulletin board element data as the URLs for discriminating the personal home pages and the Web pages of the bulletin boards, and as key words, which are parts of the URLs. Besides, the web page classifier 502 performs a processing for detecting the use of a specific CGI (Common Gateway Interface), and/or for detecting a pattern peculiar to the bulletin board in an HTML (Hyper Text Markup Language) source of the Web page.

Concerning a Web page judged to be a personal home page or a Web page of a bulletin board, the industry type determining unit 503 refers to the industry type glossary stored in the industry type glossary storage 514 to determine the industry type by making a judgment as to which industry type includes more keywords matching the Web page.

The statement and thread extractor 504 extracts each statement included in the Web page of the bulletin board, and extracts a thread which constitutes an argument as to a specific topic with some statements. In this processing, a statement is cut out based on a repeated pattern of prescribed tags in the HTML source. The thread is extracted based on “Re:” phrases included in the title of a statement, links to the former or latter statement, and the like. Concerning the personal homepage, one Web page is treated as one statement, or for example, a paragraph of a predetermined size is cut out as one statement. Incidentally, there is also a case where one Web page is treated as a thread.

The company specifying unit 505 uses the company name dictionary stored in the company name dictionary storage 515 and specifies a company name, which is talked about, from a character string appearing in the statement or the thread. The company name dictionary includes a URL company name dictionary and an abbreviation name dictionary. There is also a case where a symbol or code of a company talked about and/or a company URL is specified by using the URL company name dictionary.

The source search unit 506 extracts a URL, which can be the basis of the statement and/or information of the mass media such as newspapers and/or magazines in the statement or the personal homepage. This processing uses the mass media dictionary including company names relating to the mass media such as newspapers and/or magazines, names of newspapers and/or magazines, and the like. The mass media dictionary is stored in the mass media dictionary storage 516.

The statement and thread analyzer 507 analyzes the contents of the statement and thread, and acquires information as to genres (for example, product information, company information, stock price information, environment activity information, etc.) of the topic of the statement and thread, and/or information of evaluation as to a company of the topic of the statement and thread. With respect to the evaluation, for example, the statement and thread analyzer 507 judges whether the statement has a good evaluation or a bad evaluation. For preparation to determine the genre and the evaluation, learning is performed by using correct answer sets of genres and correct answer sets of good evaluations and bad evaluations, which are previously prepared for each industry type, to generate a rule set, and this rule set is stored in the rule set storage 517 and used by the statement and thread analyzer 507. Besides, the statement and thread analyzer 507 judges whether the statement includes information expressing a speaker's identity such as a mail address or a handle, and/or information indicating the basis such as the URL, and determines the reliability of the statement on the basis of that information. With respect to the URL, the statement and thread analyzer 507 confirms whether it is included in the company name dictionary by accessing the company name dictionary storage 515, and with respect to the handle, the statement and thread analyzer 507 refers to the data in the handle DB 518 to judge whether it is included. The processing results of the statement and thread analyzer 507 are stored in the analyzed data storage 510.

The statistical processor 508 executes various statistical processings. Although a predetermined statistical processing may be executed in advance, a statistical processing specified by the user operating the user terminal 3 may be executed. For example, the respective evaluations as to a specified company are summed up, the number of statements for each company is summed up, or data as to a temporal change is generated. There is also a case where the results of the statistical processing are stored in the analyzed data storage 510.

The user interface unit 509 transmits the data stored in the analyzed data storage 510 in response to a request from the user terminal 3. For example, it executes such a processing to rearrange statements and threads on the basis of the referenced degree ranking and/or the reliability and to transmit them. Besides, if a statistical processing is needed, the user interface unit 507 causes the statistical processor 508 to perform a prescribed statistical processing by using the data stored in the analyzed data storage 510, and transmits the results to the user terminal 3. For example, there is also a case where the data is processed into a graph or the like and is outputted.

The search engine 521 executes a search of content information stored in the archive 512 in response to a request from the user operating the user terminal 3. A search log of the executed search is stored in the search log storage 511.

The glossary generator 520 uses the content information stored in the archive 512, the link topology data registered in the link topology DB 519, the search log stored in the search log storage 511, and the like to generate the industry type glossary, company name dictionary including formal and informal edition URL company name dictionaries, and the abbreviation name dictionary, and stores them into the industry type glossary storage 514 and the company name dictionary storage 515.

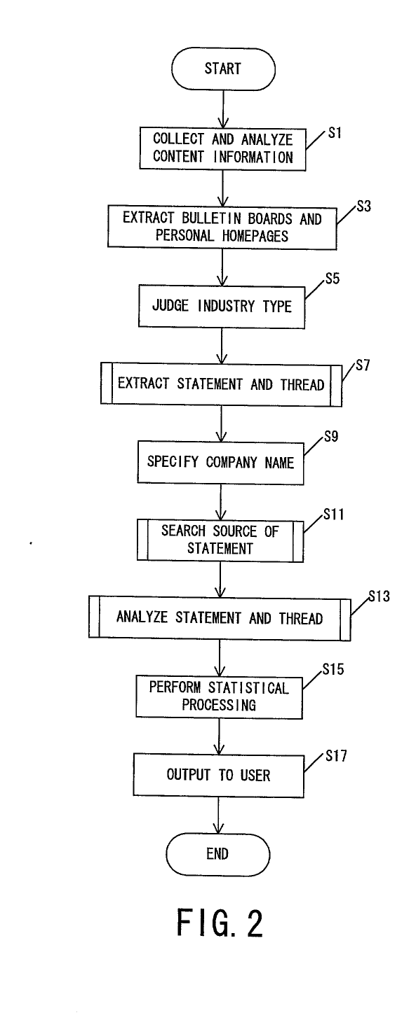

Next, the contents of the processing of the system shown in FIG. 1 will be described with reference to FIGS. 2 to 16. FIG. 2 shows the outline of the processing in this embodiment. First, a content collection and analysis processing by the content collecting and analyzing unit 501 is performed (step S1). In this processing, as described above, the data of the Web pages published by the many Web servers 7 connected to the Internet 1 are collected, and the reference relations based on the links are analyzed, so that the ranking values are calculated from the referenced degree of the respective Web pages. Then, the collected data of the Web pages and the ranking values by the referenced degrees are stored into the archive 512, and the reference relations based on the links are stored as the link topology data into the link topology DB 519.

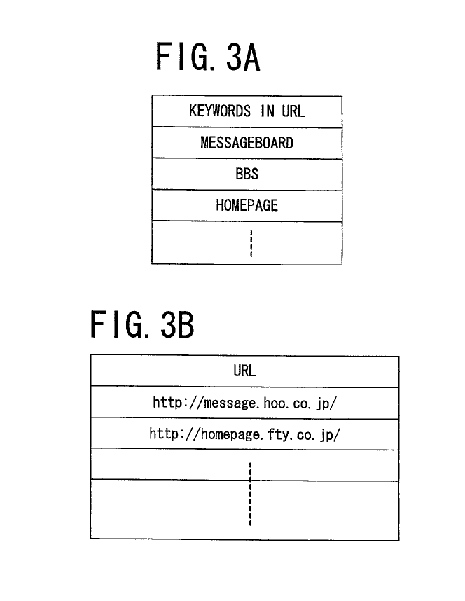

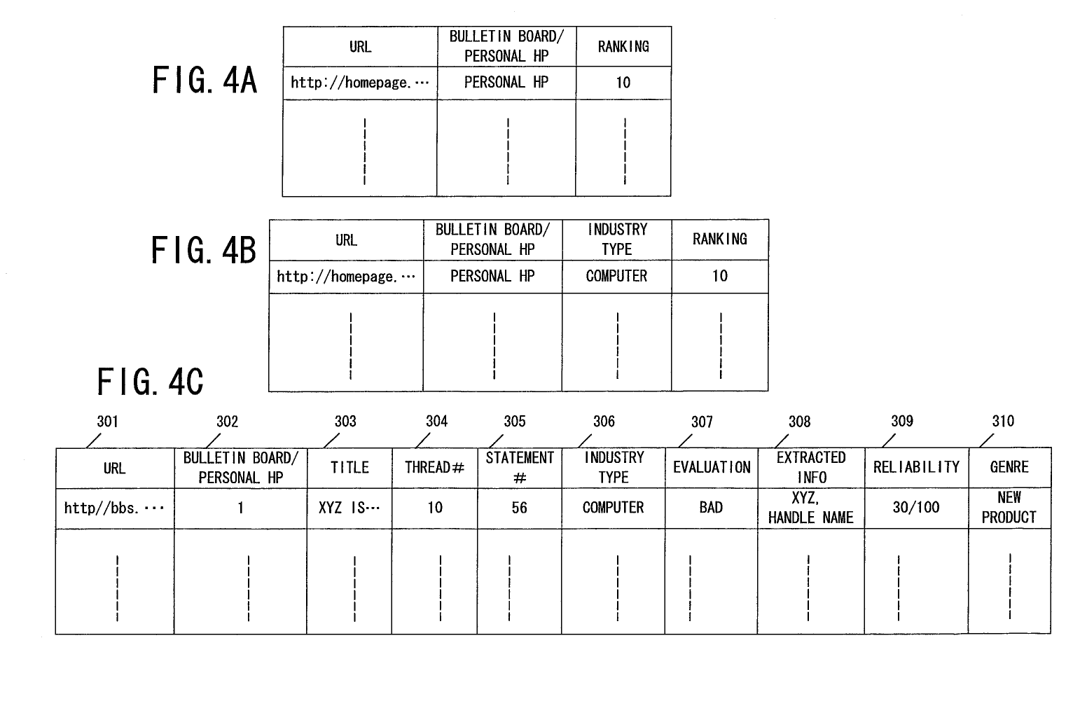

Next, the Web page classifier 502 extracts a bulletin board and a personal homepage from the content information collected by the content collecting and analyzing unit 501 and stored in the archive 512 (step S3). In this processing, the bulletin board element data stored in the bulletin board element storage 513 is used. The bulletin board element data includes key words, such as bbs, messageboard, and homepage, often used for the URL of the bulletin board and the personal homepage as shown in FIG. 3A, and URLs of generally known bulletin boards and personal homepages as shown in FIG. 3B. Besides, there is also a case where the bulletin board element data includes data for specifying CGI often used for the bulletin board and/or the personal homepage, data of the HTML source of the Web page often appearing on the bulletin board and/or the personal homepage, and the like. That is, with respect to the Web page to be processed, it is judged whether the URL or its part coincides with the URL or the keyword included in the bulletin board element data (FIGS. 3A and 3B) stored in the bulletin board element storage 513. Besides, it is judged whether the CGI used for the Web page to be processed is the CGI often used for the bulletin board and/or the personal homepage. Further, the HTML source of the Web page to be processed is analyzed, and the existence of a repeated pattern of specific tags often used for the bulletin board and/or the personal homepage is checked. These processings are carried out in descending order of the ranking value by the referenced degree, which is calculated correspondingly to the Web page. As a result of these processings, for example, as shown in FIG. 4A, the URL of the Web page judged to be the bulletin board or the personal homepage, a distinction between the bulletin board and the homepage (HP), and the referenced degree ranking value of the Web page are stored in, for example, the analyzed data storage 510.

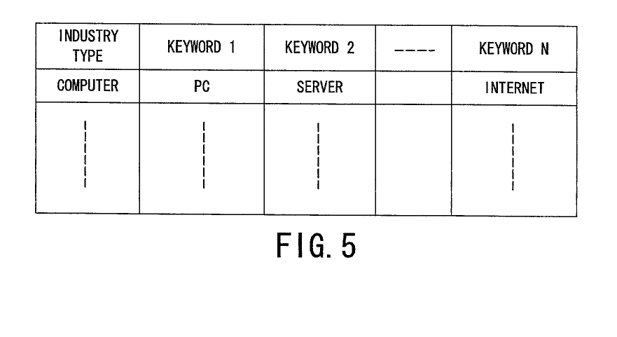

Then, the industry type determining unit 503 refers to the industry type glossary stored in the industry type glossary storage 514 with respect to the Web page judged to be the bulletin board or the personal homepage, and judges the industry type of the topic of the Web page (step S5). In the industry type glossary, as shown in FIG. 5, one or plural keywords (n (n is an integer) keywords in the drawing) are registered correspondingly to a name of an industry type. Accordingly, the industry type determining unit 503 performs matching between terms included in the Web page to be processed and the keywords registered in the industry type glossary, the industry type in which the number of matched keywords is large is judged to be the industry type of the Web page to be processed. As a result of the processing as stated above, for example, as shown in FIG. 4B, the URL of the Web page judged to be the bulletin board or the personal homepage, a distinction between the bulletin board and the personal homepage, the industry type of the topic of the Web page, and the referenced degree ranking of the Web page are stored in, for example, the analyzed data storage 510.

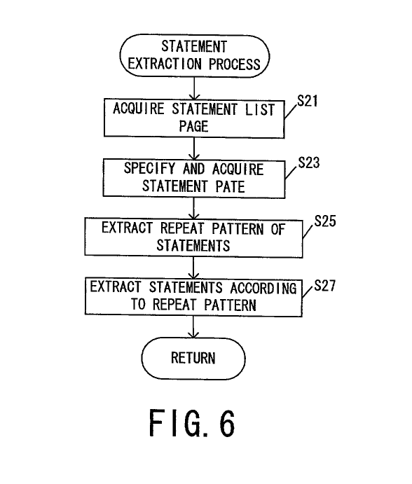

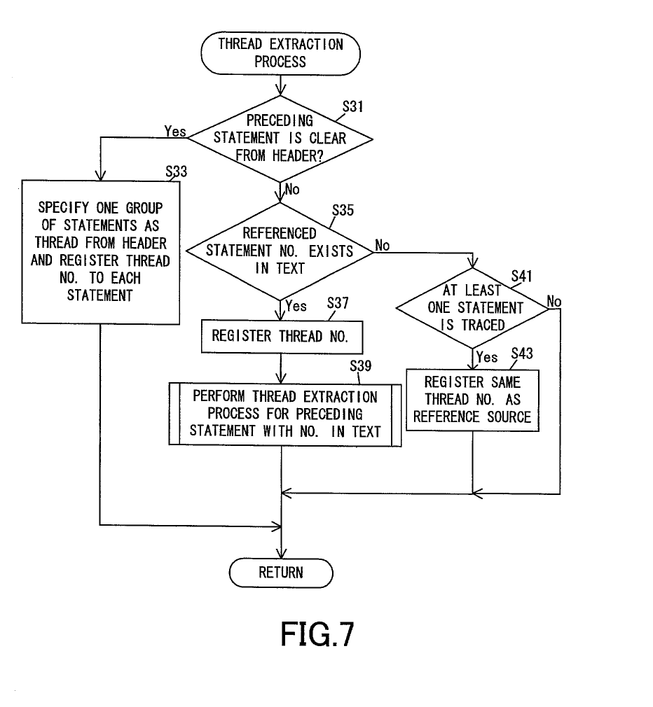

Next, the statement and thread extractor 504 extracts each statement included in the Web page of the bulletin board, and extract a thread as a statement group in the case where some statements argues or discusses a specific topic collectively (step S7). Here, a processing of extracting a statement and a processing of extracting a thread will be separately described with reference to FIGS. 6 and 7.

First, the extraction processing of the statement will be described with reference to FIG. 6. With respect to a Web page judged to be a bulletin board, its links are analyzed to extract URLs of Web pages designated by links with a character string, for example, “to a list” or “list of bulletin boards”, and data of the Web pages of such URLs are acquired as data of a statement list page and are stored into a storage device (step S21). The contents of the statement list page are analyzed, links to the respective enumerated statements are specified, data of the statement page is acquired, and it is stored into the storage device (step S23). There is also a case where a plurality of statements are included in the statement page. Accordingly, the HTML source of the statement page is analyzed, a repeat pattern of the statement is extracted, and it is stored into the storage device (step S25). For example, there is a case where a statement number, a date, a handle name and the like, such as “30:01/10/2002 22:46 ID:QpKfFIhK”, repeatedly appear in each statement as a header, and this repeat pattern is extracted. Besides, there is also a case where each statement is put in a frame. In such a case, since a TABLE tag is repeated in a specific pattern, the repeat pattern of this TABLE tag is extracted. Then, in accordance with the extracted repeat pattern, each statement is cut out and is stored into the storage device (step S27). However, in the case where the length of the statement is a predetermined length or less, the statement may be discarded.

Next, the extraction processing of the thread will be described with reference to with FIG. 7. In a bulletin board, as shown below,

“Re:XX contribution of Mr. AAAA Monday October 15, @01:42 PM

Re:XX contribution of Mr. AAAA Monday October 15, @01:45 PM

Re:XX contribution of Mr. AAAA Monday October 15, @03:01 PM

Re:XX contribution (score: 1) of Mr. BBBB, Tuesday October 16, @07:16 AM”,

there is also a case where a statement group relating to the preceding statement “XX” is apparent from the character such as “Re:”. On the other hand, as shown below,

“58 Name: Mr. CCCC January 10/21 21:11>56

With respect to this statement, . . . ”,

there is also a case where a preceding statement or a relevant statement is unclear from only the header of each statement. Accordingly, it is judged whether a preceding statement can be extracted from the header by using a character of “Re:” or the like (step S31). As in the first example mentioned above, if the preceding statement is clear (step S31: Yes route), one statement group is grasped as a thread from the header, and a thread number is given and is registered for each statement (step S33). In the first example, the statement of “XX” and the above four statements constitute one thread, and the same thread number is registered. Then, the procedure is returned to the processing of the calling source. The registered data will be described later.

On the other hand, in the case where a preceding statement can not be extracted from the header (step S31: No route), it is judged whether there is statement identification information such as a statement number of a referenced preceding statement (step S35). If such information exists, a thread number is registered for the statement to be processed (step S37). Incidentally, when a processing of tracing to the preceding statement has been already executed, a thread number given before tracing is used, and in the case where the processing of tracing has not been executed, a thread number is newly given. Then, retroactively to the referenced preceding statement, the thread extraction processing of FIG. 6 is recursively executed (step S39) On the other hand, in the case where the statement number of the preceding statement is not included in the text (step S35: No route), it is judged whether or not at least one statement is traced (step S41) This is because for example, there is a case of an isolated statement or there is also a case of a root statement. In the case of the isolated statement (step S41: No route), the procedure is returned to the processing of the calling source. Incidentally, even in the case of the isolated statement, if it is determined that even one statement constitutes a thread, a thread number may be newly given and registered. In case it is judged that at least one statement is traced (step S41: Yes route), the same thread number as the reference source is registered for the statement (step S43). Then, the procedure is returned to the processing of the calling source.

As stated above, in the case where a thread is known from a header, a statement group is specified by the header, and in the case where it is not known from the header, statements are traced recursively through a statement number existing in the text, so that the thread is grasped. The technique for this processing is disclosed in, for example, U.S. application Ser. No. 048026, filed on ***.

Incidentally, in the case of a personal homepage, one Web page is treated as one statement. In this case, for example, all pages, which can be referenced from the top page of the personal homepage may be treated as a thread, or the respective pages can be treated as isolated statements. Besides, there is also a case where one page is long. In such a case, it may be divided by, for example, an h1 tag of the HTML source and may be treated as one statement.

When the extraction processing of the statement and the thread at the step S7 is performed, data in the table shown in FIG. 4C is partially registered. The example of FIG. 4C includes a column 301 for a URL of a Web page including a statement, a column 302 for storing a distinction between a bulletin board and a personal homepage, a column 303 for a title of a statement, a column 304 for a thread number (#), a column 305 of a statement number (#), a column 306 of an industry type, a column 307 of an evaluation as to an object of a statement, a column 308 for storing extracted information, a column 309 of reliability, and a column 310 of a genre. In the column 302 for storing the distinction between the bulletin board and the personal homepage, “1” is stored in the case of the bulletin board, “2” is stored in the case of the personal homepage, and “3” is stored in other cases. With respect to the title, there is a case of a title of a statement, or there is also a case of a value between TITLE tags or H1 tags. With respect to the evaluation, for example, a good or bad evaluation is stored. This will be described later. The extracted information includes a company name, a securities code or symbol, a reference statement number, information of mass media or URL as the basis of the statement, a mail address and a handle name as information indicating the identity. The reliability includes a referenced degree ranking value of the page including the statement, and a value of the reliability calculated below. The genre is a topic common to the respective industry types, such as product information, company information, stock price information, or environment activity information.

When the processing up to the step S7 is performed, values are stored in the column 301 for the URL, the column 302 for storing the distinction between the bulletin board and the personal homepage, the column 303 for the title, the column 304 of the thread number, and the column 305 of the statement number.

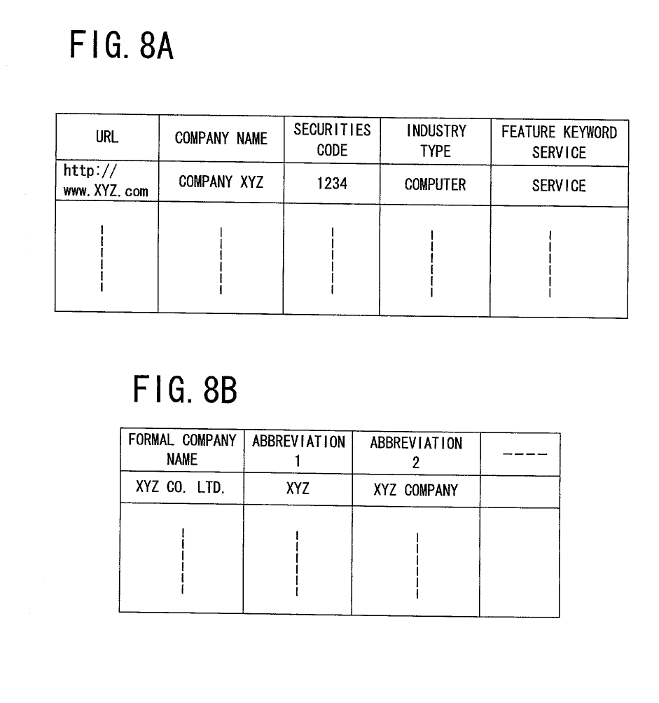

The description is returned to FIG. 2, and subsequently to the step S7, the company specifying unit 505 performs a processing for specifying a name of a company, which is an object of the statement (step S9). For this processing, the company specifying unit 505 refers to the company name dictionary stored in the company name dictionary storage 515. The company name dictionary includes the URL company name dictionary and the abbreviation name dictionary. Examples of these dictionaries are shown in FIGS. 8A and 8B. FIG. 8A shows the example of the URL company name dictionary. In the example of FIG. 8A, a URL, a company name, a securities code or symbol, a name of an industry type, and feature keywords are stored for each company. FIG. 8B shows the example of the abbreviation name dictionary. In the example of FIG. 8B, a formal company name, and one or plural abbreviations are stored. By using these dictionaries, it is judged whether words included in the statement to be processed coincide with the company name, the abbreviation, and the securities code or symbol in the dictionaries, and the company name is specified. Incidentally, not only the company name but also the securities code or symbol and the company URL may be specified. Also with respect to the personal homepage, the name of the company as the object of the statement is similarly specified. Here, the specified company name, the securities code or symbol and the like are stored in the column 308 for storing the extracted information of FIG. 4C.

Next, the source search unit 506 extracts the URL and/or the information of the mass media such as the name of a newspaper and/or magazine, which can be the basis of the statement (step S11). Incidentally, with respect to the information of the mass media, the mass media dictionary stored in the mass media dictionary storage 516 is used. Besides, although FIG. 1 does not show, the source search unit 506 may refer to the company name dictionary stored in the company name dictionary storage 515, and if the URL is included in the statement, the source search unit 506 judges whether the URL is the URL registered in the company name dictionary to register the URL or the company name in the analyzed data storage 510. The mass media dictionary includes information as to, for example, company names relating to the mass media, and names of newspapers and/or magazines published by those companies.

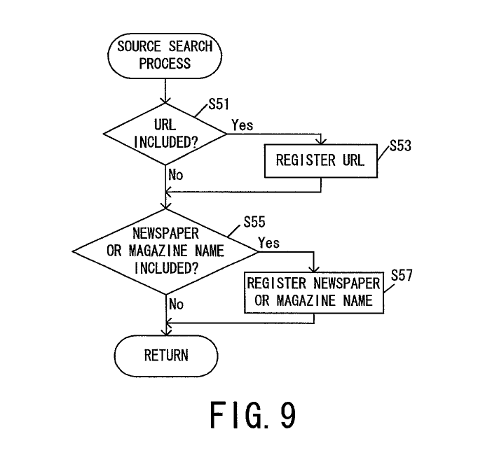

FIG. 9 shows the details of a source search processing of step S11. First, it is judged whether a URL is included in the statement or the personal homepage (step S51). Incidentally, a processing may be such that it is judged whether a URL registered in the company name dictionary is included. If a URL is included, the URL is registered in the analyzed data storage 510 (step S53). For example, it is stored in the column 308 for storing the extracted information of FIG. 4C. As described above, the information as to whether or not it is the URL registered in the company name dictionary may be registered. Besides, in the case where it is judged at the step S51 that the URL is not included, or after the URL is registered at step S53, it is judged whether the name of a newspaper or magazine is included in the statement or the personal homepage (step S55). It is judged whether or not the name of the newspaper or magazine registered in the mass media dictionary appears in the statement or the personal homepage. In case the name of the newspaper or magazine registered in the mass media dictionary is detected, the name of the newspaper or magazine is registered in the analyzed data storage 510 (step S57). For example, it is stored in the column 308 for storing the extracted information of FIG. 4C.

The description is again returned to the processing of FIG. 2, and the statement and thread analyzer 507 executes an analysis processing of the statement, the thread and the personal homepage by using the company name dictionary stored in the company name dictionary storage 515, the rule set, which is previously generated for specifying the evaluation of the object of the statement and the genre of the topic and is stored in the rule set storage 517, and the handle DB 518 as to the handle name used in the bulletin board or the like (step S13). In the analysis processing, the wording of the statement and the thread is compared with the rule set registered in the rule set storage 517 to determine the genre of the topic, and the evaluation of the objective company of the statement, such as a good or bad evaluation. Besides, the reliability of the statement is determined based on whether a URL as the basis of the statement is recited, whether the URL is the URL registered in the company name dictionary, or whether a mail address or a handle name to indicate the speaker's identity is included.

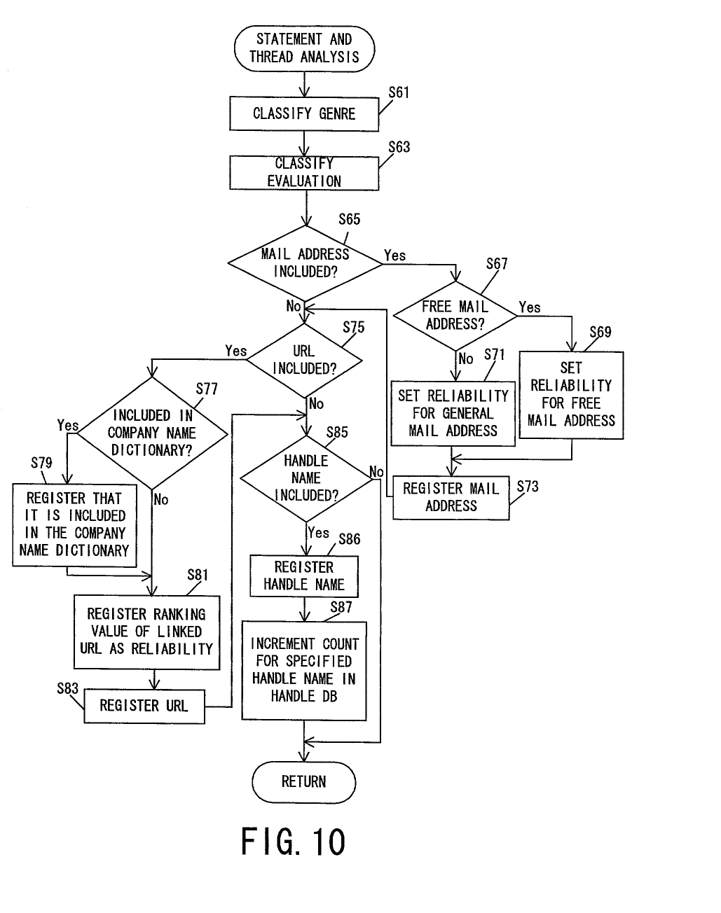

The details of the step S13 are shown in FIG. 10. Incidentally, FIG. 10 shows a processing for one statement or one personal homepage. First, the genre of the topic of the statement or the like is classified, and the genre is registered in the analyzed data storage 510 (step S61). For example, it is stored in the column 308 for storing the extracted information of FIG. 4C. Besides, the evaluation as to the objective company of the statement or the like is classified, and the information of the evaluation is registered in the analyzed data storage 510 (step S63). For example, it is stored in the column 308 for storing the extracted information of FIG. 4C. The classification of evaluation is such a classification that a good evaluation to the company is done or a bad evaluation is done. With respect to the processing of the step S61 and the step S63, the statement and thread analyzer 507 makes a judgment by using the rule set as to the genre of the topic of the statement or the like and the rule set as to the good evaluation or the bad evaluation, which are stored in the rule set storage 517. These rule sets are generated for each industry type. This is because it is conceivable that the expression as to the genre or the wording as to the evaluation is different between industry types. As to the genre, there is also a case where the bulletin board itself is categorized, and the information as to the category of the bulletin board may be used. As to the evaluation, in addition to the good evaluation and the bad evaluation, the statement and thread analyzer 507 may judges as to whether the evaluation is concerned with a predetermined viewpoint may be made.

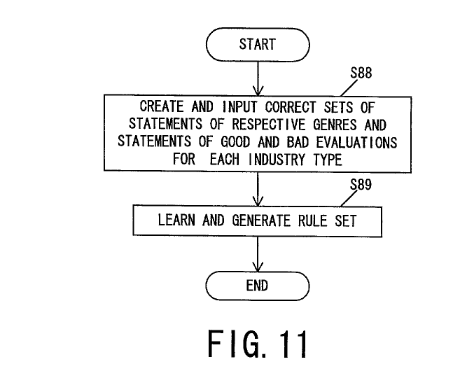

For example, a processing as shown in FIG. 11 is carried out to generate the rule set. That is, correct answer sets of statements of respective genres, and statements of good evaluation and bad evaluation for respective industry types are manually created, and are inputted to the statement and thread analyzer 507 having, for example, an expert system function (step S88). Then, learning of the correct answer sets is carried out, and the rule set is generated and is stored in the rule set storage 517 (step S89).

Returning again to the processing of FIG. 10, next, it is judged whether a mail address is included in the statement or the like (step S65). In case the mail address is included in the statement or the like (step S65: Yes route), it is judged whether or not the mail address is the mail address of a free mail (step S67). Whether or not it is the mail address of the free mail can be judged from, for example, the pattern of the domain portion of the mail address. In case it is the mail address of the free mail (step S67: Yes route), the reliability corresponding to the mail address of the free mail is set and is registered in the column 309 of the reliability in the analyzed data storage 510 (step S69). Incidentally, a ranking value of referenced degree of the page of the statement or the like is also registered in the column 309 of the reliability. On the other hand, in case it is not the mail address of the free mail (step S67: No route), the reliability corresponding to the general mail address is set and is registered in the column 309 of the reliability (step S71). In general, as information to clarify the speaker's identity, the general mail address has higher reliability than the mail address of the free mail, and accordingly, also with respect to the reliability, a higher value is given to the general mail address.

After the step S69 or the step S71, the detected mail address is registered in the analyzed data storage 510 (step S73). For example, it is stored in the column 308 for storing the extracted information in the analyzed data storage 510. Then, the procedure proceeds to step S75.

Next, it is judged whether a URL is included in the statement or the like (step S75). This is because the URL is often indicated as the basis of the statement. In case the URL is included in the statement or the like (step S75: Yes route), it is judged whether the URL is included in the company name dictionary (step S77). In case the URL is included in the company name dictionary, that the URL is included in the company name dictionary is registered in the analyzed data storage 510 (step S79). For example, it is stored in the column 308 for storing the extracted information. After the step S79 or in the case where it is judged at the step S77 that the URL is not included in the company name dictionary, the ranking value of the referenced degree of the linked URL is registered as the reliability (step S81). For example, it is registered in the column 309 of the reliability in the analyzed data storage 510. Incidentally, in the case where the mail address is also included in the statement or the like, the reliability as to the mail address and the reliability as to the URL may be added. Besides, the ranking value of the referenced degree of the statement or the like is also registered. Then, the URL is registered in the analyzed data storage 510 (step S83). For example, it is stored in the column 308 for storing the extracted information. The processing proceeds to step S85.

Next, it is judged whether a handle name is included in the statement or the like (step S85). The handle name is often used in the bulletin board and is information for specifying a speaker, however, it can not completely specify the speaker. Accordingly, in this embodiment, the number of statements is used as an index. In the case where the handle name is included in the statement or the like, the handle name is registered in the analyzed data storage 510 (step S86) Then, the handle name is searched in the handle DB 518, and its count is incremented if it is found (step S87).In the case where the handle name has not been registered in the handle DB 518, the handle name and the initial count is registered. Then, the procedure proceeds to a next processing. In the case where it is judged that the handle name is not included in the statement or the like, the procedure also proceeds to a next processing.

Incidentally, with respect to the reliability of the handle name, count values are used which are registered in the handle DB 518 at the point of time when the processing as to the whole content information collected once by the content collecting and analyzing unit 501 is ended. That is, at the point of time when the processing as to the whole content information is ended, the count values as to the respective handle names of the handle DB 518 are registered in the analyzed data storage 510.

In the case where the reliability is finally compared, a normalization processing may be required. For example, in the case where the reliability of “30” is given to a general mail address and the reliability of “10” is given to a mail address of a free mail, there is a case where with respect to a referenced degree ranking value of a link destination URL used as the reliability of the URL, it becomes necessary to use a value obtained by dividing it by 100, or also with respect to the count value of the handle name, it becomes necessary to use a value obtained by dividing it by 20, for example.

By the processing of the step S13 in FIG. 2, the information is registered in the analyzed data storage 510, in the column 309 of the reliability, the column 310 of the genre, and the column 308 for storing the extracted information.

In FIG. 2, the statistical processor 508 next performs various statistical processings (step S15). The statistical processor 508 calculates and generates information, for example, with respect to the total of good or bad evaluations of the respective genres of the respective industry types and the ratio seen from the whole, the sum of the company names appearing in the statement, the sum of good or bad evaluations, information as to what statements from what viewpoint abound, and information as to what evaluations abound. The statistical processor 508 may arrange data in order of the reliability of the statement or the ranking value of the referenced degree.

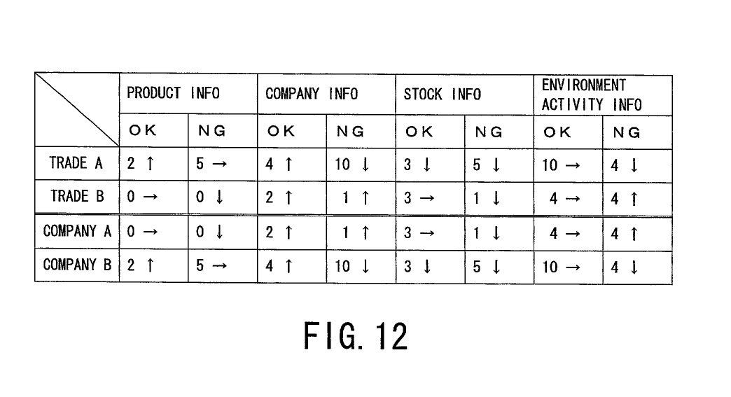

For example, information as shown in FIG. 12 is generated. Here, with respect to each of product information, company information, stock price information, and environment activity information, the number of statements of good evaluation (OK) and the number of statements of bad evaluation (NG) concerning trade A, Trade B, company A and company B are included. An upward arrow indicates that the number is increased from that at the time of the preceding processing, a horizontal arrow indicates that the number is almost the same as that at the time of the preceding processing, and a downward arrow indicates that the number is decreased from that at the time of the preceding processing.

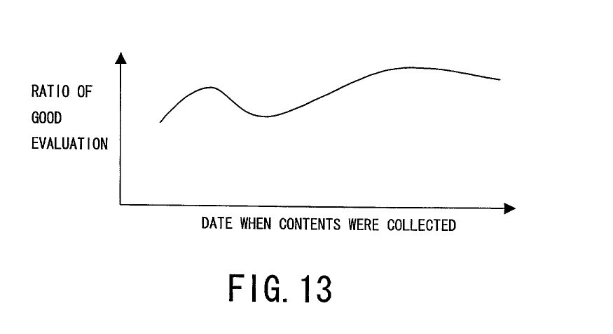

Besides, there is also a case where information as shown in FIG. 13 is generated. That is, a graph shows a temporal change of the ratio of good evaluation in the statements relating to the company A.

The results of the statistical processing as stated above are registered in, for example, the analyzed data storage 510. Then, the user interface unit 509 reads out the information registered in the analyzed data storage 510 in response to a request from the user terminal 3, and transmits it to the user terminal 3 (step S17). In addition to the data processed by the statistical processor 508, the user interface unit 509 may sort it in accordance with, for example, the reliability of the statement or the ranking value of the referenced degree, and transmit the results to the user terminal 3, or the user interface unit 509 may search the analyzed data storage 510 by a keyword or the like specified by the user, and transmit the search results to the user terminal 3.

By means of the display device of the user terminal 3, the user can obtain information as to how many statements of what evaluation were made to what industry type or company, and as to the source of the information. In stock dealings, it becomes possible to obtain information as to whether there is information equivalent to “circulation of rumor”, and information as to the source of such information. It also becomes possible to take the influence degrees of the statements based on the reliability, and/or the ranking value of the referenced degree into account at the judgment with respect to such obtained information.

The data of the industry type glossary storage 514 and the company name dictionary storage 515 may be generated by any methods. However, it is also possible to generate it by using the content information collected by the content collecting and analyzing unit 501. In this embodiment, by using a technique for distinctively extracting and classifying information of a specified industry type or a field from a large amount of information, the glossary generator 520 in FIG. 1 generates the industry type glossary, the URL company name dictionary, and the abbreviation name dictionary.

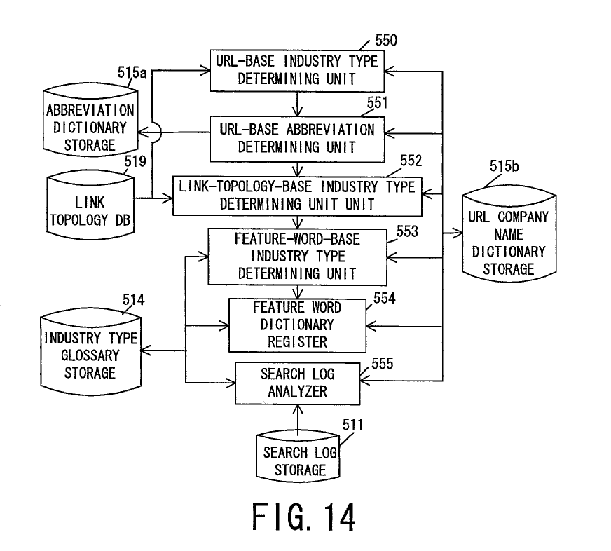

FIG. 14 is a functional block diagram of the glossary generator 520 of FIG. 1. The glossary generator 520 includes a URL-base industry type determining unit 550, a URL-base abbreviation determining unit 551, a link-topology-base industry type determining unit 552, a feature-word-base industry type determining unit 553, a feature word dictionary register 554, and a search log analyzer 555. These processing units can access the URL company name dictionary storage 515b. Besides, the URL-base industry type determining unit 550 and the link-topology-base industry type determining unit 552 performs a processing by using the data of the link topology DB 519. The feature-word-base industry type determining unit 553, the feature word dictionary register 554, and the search log analyzer 555 can access the industry type glossary storage 514. Besides, the search log analyzer 555 can access the search log storage 511.

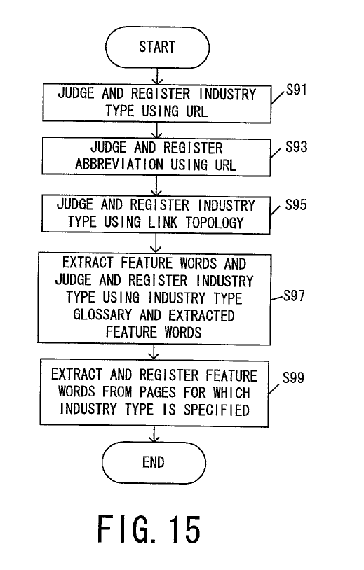

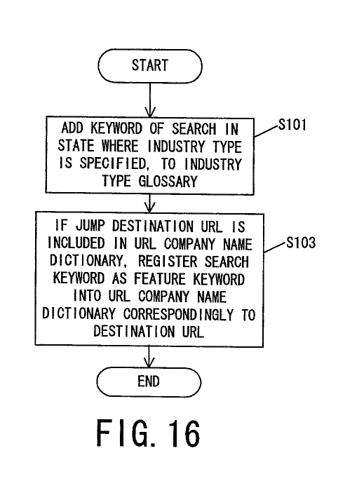

Next, the processing of the glossary generator 520 shown in FIG. 14 will be described with reference to FIGS. 15 and 16. By using the content information collected by the content collecting and analyzing unit 501 and stored in the archive 512, and the link topology data stored in the link topology DB 519, the URL-base industry type determining unit 550 performs a processing for judging and registering an industry type using URLs (step S91). First, the URL company name dictionary manually maintained to some degree is used. The industry type is judged by comparing a URL of a Web page to be processed with URLs registered in the URL company name dictionary. For example, in the case where an item of “http://www.xxx.com, XXXCo., Ltd., Computer” is registered in the URL company name dictionary, if the URL of the Web page to be processed is “http://www.ist.xxx.com”, since “xxx” is common, a candidate of the industry type of the company opening the Web page to be processed to the public is made “computer”. Then, from the link topology data stored in the link topology DB 519, it is judged whether there is a mutual or one-way link between Web pages subsequent to “http://www.xxx.com” and Web pages subsequent to “http://www.ist.xxx.com”. If it is confirmed that there is a link, the company name is extracted from the title of the Web page to be processed or the like, and then, the company name, “http://www.ist.xxx.com”, and “computer” as the industry type are registered in the company name URL dictionary.

Next, the URL-base abbreviation determining unit 551 refers to the URL company name dictionary stored in the URL company name dictionary storage 515b, and performs a processing for judging and registering abbreviations using URLs (step S93). In the case where a description of <a href=“http://www.xxx.com”>three eks </a>exists in the web page to be processed, the URL company name dictionary is searched by using “http://www.xxx.com”. If registered, the formal name of the company using “http://www.xxx.com” can be obtained. Then, the abbreviation name dictionary stored in the abbreviation dictionary storage 515a is searched with the formal name, and it is confirmed whether the formal name is registered. If registered, it is confirmed whether “three eks” is registered correspondingly to the formal name. If not registered, “three eks” is registered in the abbreviation dictionary. In the case where the formal name is not registered, the formal name and the abbreviation of “three eks” are registered. However, it is necessary to confirm that a typical word not an abbreviation, such as “here” not “three eks”, is not used.

Then, the link-topology-base industry type determining unit 552 uses the link topology data stored in the link topology DB 519 to perform a processing for judging and registering an industry type (step S95). It is judged that a company whose page has a close link relation to a company site registered in the URL company name dictionary belongs to the same industry type as the company site, and the URL of the page, and the company name and industry type extracted by using the information in the page are registered in the URL company name dictionary. If the URL or the like is already registered, the industry type is registered. In the case where a hub site having a specified industry type can be extracted from the link topology data, it is judged that a company whose page is linked from the hub site belongs to the same specific industry type, and the URL of the linked page, and the company name and industry type extracted by using the information in the page are registered in the URL company name dictionary. If the URL or the like is already registered, the industry type is registered.

The feature-word-base industry type determining unit 553 extracts a feature word from the Web page to be processed in accordance with a predetermined algorithm, searches the industry type glossary by the feature word, and performs a processing for judging and registering an industry type of the Web page to be processed (step S97). In the case where feature words extracted from the Web page coincide with terms registered in the industry type glossary concerning a specified industry type at a level higher than a specified standard, the specified industry type is judged to be the industry type of the Web page to be processed. Then, the URL of the Web page, and the company name and industry type extracted by using the information in the page are registered in the URL company name dictionary. If the URL or the like is already registered, the industry type is registered. The algorithm for extracting feature words is well-known, therefore further description is omitted. Further, the feature word dictionary register 554 extracts feature words from the page in which the industry type is specified, and registers the feature words in the industry type glossary (step S99). The feature words are extracted from the page in which the industry type is specified by the foregoing processing and the like, and the extracted feature words become candidates to be included in the industry type glossary for the specified industry type. Such processing is executed for many pages, and in the case where a specific feature word is extracted for the same industry type at a predetermined number of times or more, the specific feature word is registered in the industry type glossary for the specified industry type. A feature word having a high extraction frequency is important, therefore feature words are registered in descending order of extraction frequency. The importance maybe judged based on a degree how late the feature word appears. The industry type glossary may be divided into a formal edition and an informal edition. For example, in the case where the Web page to be processed is a bulletin board or a personal homepage, the extracted feature word is registered in the informal edition of the industry type glossary.

In this way, the industry type glossary, the URL company name dictionary, and the abbreviation dictionary are maintained by using the content information registered in the archive 512.

Incidentally, the glossary generator 520 also executes a processing on the basis of the search log outputted from the search engine 521 executing a search processing of the archive 512 in response to the search request by the user operating the user terminal 3. This processing will be described with reference to FIG. 16.

The search log analyzer 555 uses the search log stored in the search log storage 511 to perform a search in the state where the industry type is specified, and the search key word in the search is registered in the industry type glossary (step S101). Incidentally, it may be registered in the informal edition of the industry type glossary. Besides, if a jump destination URL of the user is registered in the URL company name dictionary, the search keyword is registered as the feature keyword into the URL company name dictionary correspondingly to the URL (step S103).

By doing so, the industry type glossary can be expanded by using the search log. Besides, the feature keywords in the URL company name dictionary can also be expanded.

In the above, although the embodiment of the present invention has been described, the present invention is not limited to this. That is, the functional block configuration in the information collection and analysis system 5 shown in FIG. 1 is one example, and another configuration may be adopted. Besides, in the processing flow of FIG. 2, with respect to the execution order of the source search processing (step S11), it may be executed at the same time as the statement and thread extraction (step S7) or after that. Also in FIG. 9, the order of the step S51 and the step S53, and the order of the step S55 and the step S57 can be changed. Also in FIG. 10, the order of the step S61, the step S63, and the steps S65 to S89 can be changed. The functional block configuration in FIG. 14 is also one example, and another configuration may be adopted. In the processing steps in FIG. 15, the execution order can be changed.

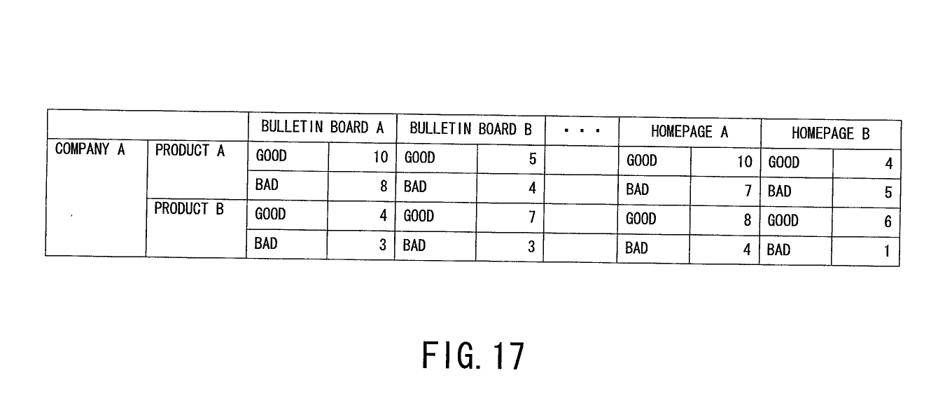

In the above, although the description has been given for the information collection and analysis as to a company, a book review or the like may be made an object. Besides, although FIGS. 12 and 13 show the examples of the output of the user interface unit 509, not only company name but also product name may be extracted from the bulletin board and/or the personal homepage, and be stored in, for example, the column 308 for storing the extracted information (FIG. 4), and the user interface unit 509 may output, for example, the information as shown in FIG. 17 to the user terminal 3. That is, with respect to each product and each company, counting as to how far (how many times) a good evaluation (GOOD) is made, or how far (how many times) a bad evaluation (BAD) is made in bulletin boards and/or personal homepages, may be performed with respect to the data stored in the analyzed data storage 510, and the results may be presented to the user.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A content information analyzing method, comprising the steps of:
extracting a disclosure unit of an individual opinion from collected content information;
specifying an object of said individual opinion; and
analyzing a disclosed content of said individual opinion and specifying an evaluation as to said object of said individual opinion.

2. The content information analyzing method as set forth in claim 1, wherein said extracting step comprises the steps of:
specifying a unit of said collected content information including said individual opinion; and
extracting said disclosure unit of said individual opinion from the specified unit of said collected content information.

3. The content information analyzing method as set forth in claim 2, wherein said step of specifying a unit of said collected content information is carried out in descending order of a referenced degree for each said unit of said collected content information.

4. The content information analyzing method as set forth in claim 1, wherein said extracting step comprises a step of detecting a group of said disclosure units of said individual opinions by tracing a reference source of said individual opinion.

5. The content information analyzing method as set forth in claim 1, wherein said extracting step comprises a step of specifying a category as to said object of said individual opinion.

6. The content information analyzing method as set forth in claim 5, wherein said analyzing step comprises a step of analyzing a disclosed content of said individual opinion based on said category as to said object of said individual opinion and specifying an evaluation as to said object of said individual opinion.

7. The content information analyzing method as set forth in claim 1, further comprising a step of judging whether information that can be a basis of said individual opinion is included in said disclosure unit of said individual opinion.

8. The content information analyzing method as set forth in claim 1, further comprising a step of specifying a genre of said disclosed content of said individual opinion.

9. The content information analyzing method as set forth in claim 1, further comprising a step of determining reliability of said disclosure unit of said individual opinion.

10. The content information analyzing method as set forth in claim 9, wherein said determining step comprises a step of judging whether information indicating an identity of the individual is included in said disclosure unit of said individual opinion.

11. The content information analyzing method as set forth in claim 9, wherein said determining step comprises a step of judging whether information that can be a basis of said individual opinion is included in said disclosure unit of said individual opinion.

12. The content information analyzing method as set forth in claim 1, wherein said step of specifying an object of said individual opinion comprises a step of specifying an object of said individual opinion by using a dictionary on at least one of a Uniform Resource Locator (URL), a company name, an abbreviation, and an industry type.

13. The content information analyzing method as set forth in claim 12, further comprising a step of registering information concerning an industry type corresponding to a company name into said dictionary by using at least one of a URL of said collected content information and a similar URL registered in said dictionary.

14. The content information analyzing method as set forth in claim 12, further comprising a step of registering an abbreviation into said dictionary by using anchored character information on said collected content information and a URL of a link destination represented on said collected content information.

15. The content information analyzing method as set forth in claim 12, further comprising a step of registering information concerning an industry type corresponding to a company name by using information of a link topology obtained by analyzing a link relation among said collected content information.

16. The content information analyzing method as set forth in claim 12, further comprising a step of extracting a feature word from said collected content information, specifying an industry type based on the extracted feature word by using a feature word dictionary including feature words as to respective industry types, and registering information concerning an industry type corresponding to a company name into said dictionary.

17. The content information analyzing method as set forth in claim 5, wherein said step of specifying a category comprises a step of specifying an industry type of a company, which is an object of said individual opinion, by using a second dictionary as to feature words, which corresponds to respective industry types.

18. The content information analyzing method as set forth in claim 17, further comprising a step of extracting a feature word from said collected content information in which an industry type is specified, and adding the extracted feature word into said second dictionary correspondingly to said industry type.

19. The content information analyzing method as set forth in claim 17, further comprising a step of identifying, in a search log for said collected content information, a keyword of a search in a state where an industry type is already specified, and registering the identified keyword as a feature word into said second dictionary.

20. The content information analyzing method as set forth in claim 12, further comprising the steps of:
judging whether a jump destination URL of a searcher included in a search log for said collected content information is included in said dictionary; and
adding a search keyword included in said search log to said dictionary if it is judged to be included in said dictionary.

21. A content information analyzing method, comprising the steps of:
extracting a disclosure unit of an individual opinion from collected content information;
specifying an object of said individual opinion; and
determining reliability of said disclosure unit of said individual opinion.

22. A program embodied on a medium for causing a computer to perform a content information analysis, said program comprising the steps of:
extracting a disclosure unit of an individual opinion from collected content information;
specifying an object of said individual opinion; and
analyzing a disclosed content of said individual opinion and specifying an evaluation as to said object of said individual opinion.

23. The program as set forth in claim 22, wherein said extracting step comprises the steps of:
specifying a unit of said collected content information including said individual opinion; and
extracting said disclosure unit of said individual opinion from the specified unit of said collected content information.

24. The program as set forth in claim 23, wherein said step of specifying a unit of said collected content information is carried out in descending order of a referenced degree for each said unit of said collected content information.

25. The program as set forth in claim 22, wherein said extracting step comprises a step of detecting a group of said disclosure units of said individual opinions by tracing a reference source of said individual opinion.

26. The program as set forth in claim 22, wherein said extracting step comprises a step of specifying a category as to said object of said individual opinion.

27. The program as set forth in claim 26, wherein said analyzing step comprises a step of analyzing a disclosed content of said individual opinion based on said category as to said object of said individual opinion and specifying an evaluation as to said object of said individual opinion.

28. The program as set forth in claim 22, further comprising a step of judging whether information that can be a basis of said individual opinion is included in said disclosure unit of said individual opinion.

29. The program as set forth in claim 22, further comprising a step of specifying a genre of said disclosed content of said individual opinion.

30. The program as set forth in claim 22, further comprising a step of determining reliability of said disclosure unit of said individual opinion.

31. The program method as set forth in claim 30, wherein said determining step comprises a step of judging whether information indicating an identity of the individual is included in said disclosure unit of said individual opinion.

32. The program as set forth in claim 30, wherein said determining step comprises a step of judging whether information that can be a basis of said individual opinion is included in said disclosure unit of said individual opinion.

33. The program as set forth in claim 22, wherein said step of specifying an object of said individual opinion comprises a step of specifying an object of said individual opinion by using a dictionary on at least one of a Uniform Resource Locator (URL), a company name, an abbreviation, and an industry type.

34. The program as set forth in claim 33, further comprising a step of registering information concerning an industry type corresponding to a company name into said dictionary by using at least one of a URL of said collected content information and a similar URL registered in said dictionary.

35. The program as set forth in claim 33, further comprising a step of registering an abbreviation into said dictionary by using anchored character information on said collected content information and a URL of a link destination represented on said collected content information.

36. The program as set forth in claim 33, further comprising a step of registering information concerning an industry type corresponding to a company name by using information of a link topology obtained by analyzing a link relation among said collected content information.

37. The program as set forth in claim 33, further comprising a step of extracting a feature word from said collected content information, specifying an industry type based on the extracted feature word by using a feature word dictionary including feature words as to respective industry types, and registering information concerning an industry type corresponding to a company name into said dictionary.

38. The program as set forth in claim 26, wherein said step of specifying a category comprises a step of specifying an industry type of a company, which is an object of said individual opinion, by using a second dictionary as to feature words, which corresponds to respective industry types.

39. The program as set forth in claim 38, further comprising a step of extracting a feature word from said collected content information in which an industry type is specified, and adding the extracted feature word into said second dictionary correspondingly to said industry type.

40. The program as set forth in claim 38, further comprising a step of identifying, in a search log for said collected content information, a keyword of a search in a state where an industry type is already specified, and registering the identified keyword as a feature word into said second dictionary.

41. The program as set forth in claim 33, further comprising the steps of:
judging whether a jump destination URL of a searcher included in a search log for said collected content information is included in said dictionary; and
adding a search keyword included in said search log to said dictionary if it is judged to be included in said dictionary.

42. A program embodied on a medium for causing a computer to perform a content information analysis, said program comprising the steps of:
extracting a disclosure unit of an individual opinion from collected content information;
specifying an object of said individual opinion; and
determining reliability of said disclosure unit of said individual opinion.

43. A content information analyzing system, comprising:
means for extracting a disclosure unit of an individual opinion from collected content information;
means for specifying an object of said individual opinion; and
means for analyzing a disclosed content of said individual opinion and specifying an evaluation as to said object of said individual opinion.

44. The content information analyzing system as set forth in claim 43, wherein said means for extracting comprises:
means for specifying a unit of said collected content information including said individual opinion; and
means for extracting said disclosure unit of said individual opinion from the specified unit of said collected content information.

45. The content information analyzing system as set forth in claim 44, wherein said means for specifying a unit of said collected content information processes said collected content information in descending order of a referenced degree for each said unit of said collected content information.

46. The content information analyzing system as set forth in claim 43, wherein said means for extracting comprises means for detecting a group of said disclosure units of said individual opinions by tracing a reference source of said individual opinion.

47. The content information analyzing system as set forth in claim 43, wherein said means for extracting comprises means for specifying a category as to said object of said individual opinion.

48. The content information analyzing system as set forth in claim 47, wherein said means for analyzing comprises means for analyzing a disclosed content of said individual opinion based on said category as to said object of said individual opinion and specifying an evaluation as to said object of said individual opinion.

49. The content information analyzing method as set forth in claim 43, further comprising means for judging whether information that can be a basis of said individual opinion is included in said disclosure unit of said individual opinion.

50. The content information analyzing system as set forth in claim 43, further comprising means for specifying a genre of said disclosed content of said individual opinion.

51. The content information analyzing system as set forth in claim 43, further comprising means for determining reliability of said disclosure unit of said individual opinion.

52. The content information analyzing system as set forth in claim 51, wherein said means for determining comprises means for judging whether information indicating an identity of the individual is included in said disclosure unit of said individual opinion.

53. The content information analyzing system as set forth in claim 51, wherein said means for determining comprises means for judging whether information that can be a basis of said individual opinion is included in said disclosure unit of said individual opinion.

54. The content information analyzing system as set forth in claim 43, wherein said means for specifying an object of said individual opinion comprises means for specifying an object of said individual opinion by using a dictionary on at least one of a Uniform Resource Locator (URL), a company name, an abbreviation, and an industry type.

55. The content information analyzing system as set forth in claim 54, further comprising means for registering information concerning an industry type corresponding to a company name into said dictionary by using at least one of a URL of said collected content information and a similar URL registered in said dictionary.

56. The content information analyzing system as set forth in claim 54, further comprising means for registering an abbreviation into said dictionary by using anchored character information on said collected content information and a URL of a link destination represented on said collected content information.

57. The content information analyzing system as set forth in claim 54, further comprising means for registering information concerning an industry type corresponding to a company name by using information of a link topology obtained by analyzing a link relation among said collected content information.

58. The content information analyzing system as set forth in claim 54, further comprising means for extracting a feature word from said collected content information, specifying an industry type based on the extracted feature word by using a feature word dictionary including feature words as to respective industry types, and registering information concerning an industry type corresponding to a company name into said dictionary.

59. The content information analyzing system as set forth in claim 47, wherein said means for specifying a category comprises means for specifying an industry type of a company, which is an object of said individual opinion, by using a second dictionary as to feature words, which corresponds to respective industry types.

60. The content information analyzing system as set forth in claim 59, further comprising means for extracting a feature word from said collected content information in which an industry type is specified, and adding the extracted feature word into said second dictionary correspondingly to said industry type.

61. The content information analyzing system as set forth in claim 59, further comprising means for identifying, in a search log for said collected content information, a keyword of a search in a state where an industry type is already specified, and registering the identified keyword as a feature word into said second dictionary.

62. The content information analyzing system as set forth in claim 53, further comprising:
means for judging whether a jump destination URL of a searcher included in a search log for said collected content information i s included in said dictionary; and
means for adding a search keyword included in said search log to said dictionary if it is judged to be included in said dictionary.

63. A content information analyzing system, comprising:
means for extracting a disclosure unit of an individual opinion from collected content information;
means for specifying an object of said individual opinion; and
means for determining reliability of said disclosure unit of said individual opinion.
